(19) United States
(12) Patent Application Publication
(10) Pub. No.: US 2009/0136202 A1
(43) Pub. Date: May 28, 2009

(54) RECORDING/PLAYBACK DEVICE AND METHOD, PROGRAM, AND RECORDING MEDIUM

(75) Inventor: Sho Murakoshi, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/267,768

(22) Filed: Nov. 10, 2008

(30) Foreign Application Priority Data
Nov. 22, 2007 (JP) 2007-302411

(51) Int. Cl. H04N 5/93

(52) U.S. Cl. 386/68; 386/E05.028

(57) ABSTRACT

A recording/playback device includes an extracting unit to extract a feature amount for detecting a content break; a break determining unit to determine the content break using the feature amount extracted with the extracting unit; an attribute determining unit to determine the attributes of a segment, such segment being made from a predetermined break to the next break based on determination by the break determining unit; and a playback unit to continuously play back the segment determined by the attribute determining unit to have the same attributes; wherein the break determining unit determines each of a first segment and a second segment included in the first segment; and wherein the playback unit has a first mode to continuously play back the first segment and a second mode to continuously play back the second segment, and switches between the first mode and the second mode when instructed externally.

### CROSS REFERENCES TO RELATED APPLICATIONS

The present invention contains subject matter related to Japanese Patent Application JP 2007-302411 filed in the Japanese Patent Office on Nov. 22, 2007, the entire contents of which are incorporated herein by reference.

### BACKGROUND OF THE INVENTION

1. Field of the Invention

The present invention relates to an information processing device and method, program, and recording medium, and in particular relates to an information processing device and method, program, and a recording medium wherein multiple predetermined segments of content data already recorded can be extracted and continuously played back.

2. Description of the Related Art

In recent years, recorders having large capacity storage regions are increasingly used. By increasing storage capacity, a television broadcast program for example can be recorded for a long period of time, for example. However, even if recording for a long period of time is enabled, the user may not necessarily view/listen for a long period of time, resulting in programs existing which are recorded onto the recorder but not played back. Also, such a program not viewed/listened to can end up not being viewed/listened to by the user and deleted from the recorder.

In light of such problems, there have been proposed arrangements that enable a user to efficiently view/listen to a recorded program, or prompt the user to view/listen to a recorded program. (e.g. refer to Japanese Unexamined Patent Application Publication No. 2003-32662 and Japanese Unexamined Patent Application Publication No. 2001-142480.)

### SUMMARY OF THE INVENTION

As the number of programs recorded increase greatly, there are situations as described above wherein programs are recorded and not played back, and end up being deleted without being viewed/listened to. Also, searching for a desired program to view/listen to from many programs is time-consuming, whereby an arrangement is desirable that enables efficiently searching for a desired program to view/listen to.

Also, a request may not be to view one entire program, but to view/listen to a predetermined segment of the program. In order to view/listen to the predetermined segment, viewing/listening from the beginning of the program and fast-forwarding to search can be performed, but searching for a desired segment in a simpler manner is desirable.

There has been recognized demand to enable predetermined information such as a program or a predetermines segment within a program that a user desires to view or listen to, to be searched for in a more simple manner.

A recording/playback device according to an embodiment of the present invention includes an extracting unit configured to extract a feature amount for detecting a content break; a break determining unit configured to determine the content break using the feature amount extracted with the extracting unit; an attribute determining unit configured to determine the attributes of a segment, such segment being made from a predetermined break to the next break based on determination by the break determining unit; and a playback unit configured to continuously play back the segment determined by the attribute determining unit to have the same attributes; wherein the break determining unit determines each of a first segment and a second segment included in the first segment; and wherein the playback unit has a first mode to continuously play back the first segment and a second mode to continuously play back the second segment, and switches between the first mode and the second mode when instructed externally.

An arrangement may be made wherein, in the case that switching from the first mode to the second mode is instructed, the playback is switched from the first segment being played back at that point-in-time to playback of the second segment, and in the case that switching from the second mode to the first mode is instructed, the playback is switched from the second segment being played back at that point-in-time to playback of the beginning of the first segment.

The first segment may be a song segment, and the second segment a segment of the chorus of the song.

The attribute determining unit may create a first table associating an identifier to identify the first segment with the starting point-in-time and ending point-in-time of the first segment, a second table associating and an identifier to associate the second segment and the first segment with the starting point-in-time and ending point-in-time of the second segment; the playback unit performing playback with reference to the first table or the second table.

A recording/playback method according to an embodiment of the present invention includes the steps of extracting a feature amount for detecting a content break; determining the content break using the feature amount; determining the attributes of a segment, such segment being made from a predetermined break to the next break based on determination by the break determining unit; and controlling continuous playback of the segment determined to have the same attributes; wherein the break determining step determines each of a first segment and a second segment included in the first segment; and wherein the playback step has a first mode to continuously play back the first segment and a second mode to continuously play back the second segment, and switches between the first mode and the second mode when instructed externally.

A program according to an embodiment of the present invention includes the steps of extracting a feature amount for detecting a content break; determining the content break using the feature amount; determining the attributes of a segment, such segment being made from a predetermined break to the next break based on determination by the break determining unit; and controlling continuous playback of the segment determined to have the same attributes; wherein the break determining step determines each of a first segment and a second segment included in the first segment; and wherein the playback step has a first mode to continuously play back the first segment and a second mode to continuously play back the second segment, and switches between the first mode and the second mode when instructed externally.

A recording medium has recorded therein a program to cause a computer to execute processing according to an embodiment of the present invention, which includes the steps of extracting a feature amount for detecting a content break; determining the content break using the feature amount; determining the attributes of a segment, such segment being made from a predetermined break to the next break based on determination by the break determining unit; and controlling continuous playback of the segment determined to have the same attributes; wherein the break determining step determines each of a first segment and a second segment included in the first segment; and wherein the playback step has a first mode to continuously play back the first segment and a second mode to continuously play back the second segment, and switches between the first mode and the second mode when instructed externally.

According to the above configuration, a predetermined segment is extracted from the content, and a predetermined segment is further extracted from such segment. The extracted segments are continuously played back, and the playback mode thereof is switched.

According to the above configuration, stored information can be searched while confirming a segment thereof.

### BRIEF DESCRIPTION OF THE DRAWINGS

FIG. 1 is a diagram illustrating an embodiment of a recording/playback device to which the present invention is applied;

FIG. 2 is a diagram illustrating the configuration of a broadcast program;

FIG. 3 is a diagram illustrating the configuration of a music-related broadcast program;

FIG. 4 is a diagram illustrating playback during song mode;

FIG. 5 is a diagram illustrating playback during song mode;

FIG. 6 is a diagram illustrating a chorus portion of a song;

FIG. 7 is a diagram illustrating playback during chorus mode;

FIG. 8 is a diagram illustrating playback during chorus mode;

FIG. 9 is a diagram illustrating playback when switching between modes;

FIG. 10 is a diagram illustrating a list;

FIG. 11 is a flowchart describing processing for list creating;

FIG. 12 is a flowchart describing playback processing; and

FIG. 13 is a diagram illustrating a recording medium.

### DESCRIPTION OF THE PREFERRED EMBODIMENTS

An embodiment of the present invention will be described below with reference to the appended drawings.

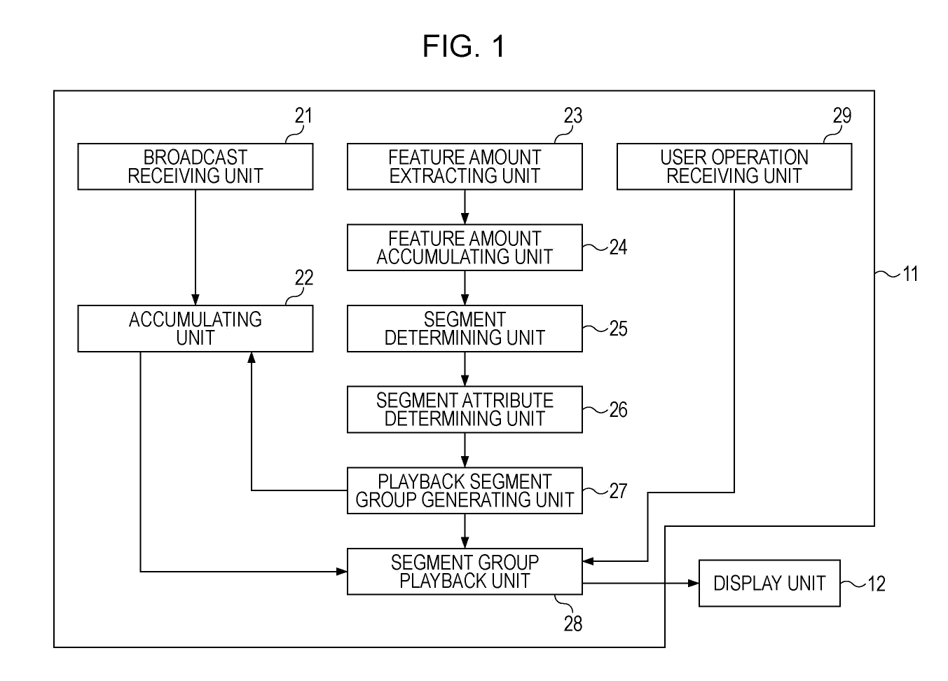

FIG. 1 is a diagram showing a configuration of an embodiment of a recording/playback device to which the present invention is applied. The recording/playback device can be applied to a recording/playback device to record a television broadcast program, for example. Accordingly, in the description hereafter, description will be continued using a television broadcast program as an example of content, but the content to which the present invention is applied is not limited to television broadcast programs.

A recording/playback device 11 shown in FIG. 1 is configured to include a broadcast receiving unit 21, accumulating unit 22, feature amount extracting unit 23, feature amount accumulating unit 24, segment determining unit 25, segment attribute determining unit 26, playback segment group generating unit 27, segment group playback unit 28, and user operation receiving unit 29.

The broadcast receiving unit 21 is connected to an antenna and cable receiving a signal from an unshown broadcasting station. The broadcast receiving unit 21 is configured to include a tuner or the like to select a television broadcast program which is obtained via the antenna and cable.

The program that is received by the broadcast receiving unit 21 and processed is accumulated in the accumulating unit 22. The program that is received by the broadcast receiving unit 21 and processed is supplied also to the feature amount extracting unit 23. The feature amount extracting unit 23 analyzes the image and audio and the supplied program, and extracts the feature amount such as edges or sound volume.

The feature amount accumulating unit 24 associates the feature amount extracted by the feature amount extracting unit 23 with an already analyzed program. The segment determining unit 25 uses the feature amount accumulated in the feature amount accumulating unit 24 to determine predetermined segments such as a scene change or the start and finish of a commercial, for example. The segment attribute determining unit 26 determines the attributes of the predetermined segments based on the determining results of the segment determining unit 25. An attribute is a segment such as a music segment, conversation segment, segment that is building up, segment with laughter therein, and so forth.

The playback segment group generating unit 27 selects segments having the same attributes from multiple programs accumulated in the accumulating unit 22. Thus, in the case that multiple segments are selected, such multiple segments are called a segment group. Segments having the same attributes are selected so as to enable continuous playback of segments associating an attribute called a song segment, for example, when the user instructs continuous playback of segments having the same attributes, in later-described processing. The playback segment group generating unit 27 creates a song segment list 51 and chorus segment list 52 which are referenced at the time of playback thereof. The segment group playback unit 28 plays back a segment group selected with the playback segment group generating unit 27. The program played back with the segment group playback unit 28 is supplied to the display unit 12.

The display unit 12 may be configured as a separate unit from the recording/playback device 11, or may be configured as an integrated unit. For example, the display unit 12 may be configured as a television receiver, and the recording playback device may be configured as a hard disk recorder connected to the television receiver. The user operating receiving unit 29 receives instruction from the remote controller or instructions when a button provided on the main unit is pressed, and performs processing.

The processing performed with the recording/playback device 11 with such a configuration will be further described. First, the recording/playback device 11 extracts a predetermined segment (described as the first segment, as appropriate) from multiple recorded programs. Also, the recording playback device 11 extracts a further predetermined segment within the first segment (described as the second segment, as appropriate), and performs processing to continuously play back the second segment. Further, the recording playback device 11 performs processing to switch the mode to continuously play back the first segment and the mode to continuously play back the second segment.

With the description below, an example will be given wherein the program is a program relating to music, the first segment is a segment within a program relating to music, and is a segment of a song playing (e.g. a scene of a singer singing), and the second segment is a chorus segment of the song in the segment of a song playing. Note that “chorus” refers to the segment in the song that builds up greatly.

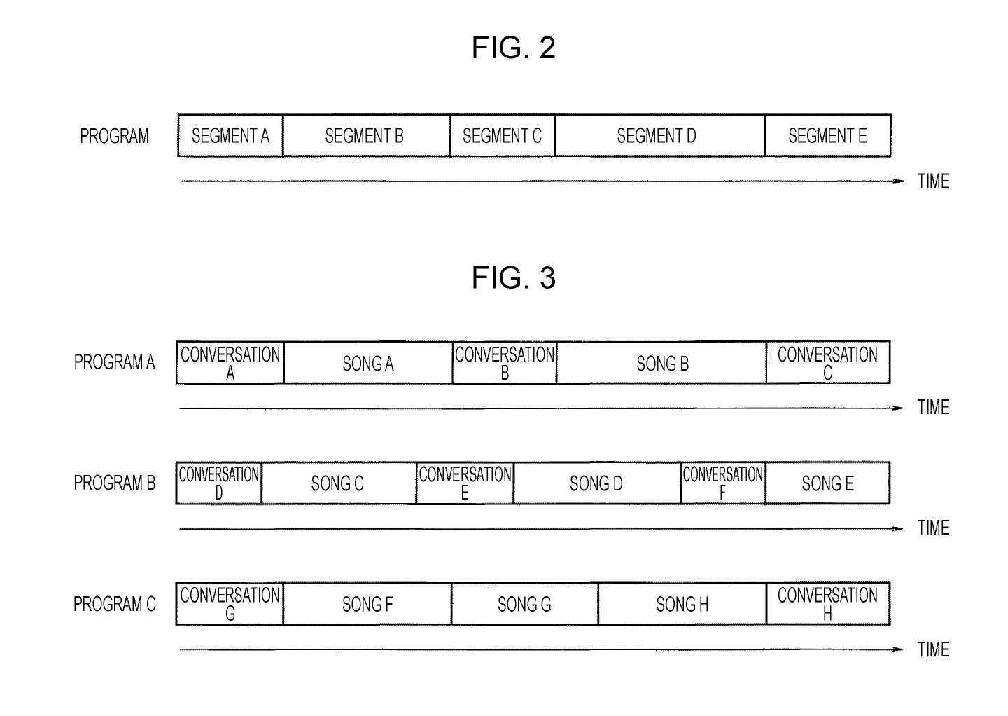

Description will be given regarding a configuration of the program content when one program is of interest, with reference to FIG. 2. Also, the first segment will be described with reference to FIG. 2.

One program can be segmented into multiple segments, as shown in FIG. 2. The example shown in FIG. 2 is an example segmented into the five segments of segment A through segment E. In the case that the program is related to music, for example, a frequent pattern is that a singer sings (the song plays) after a host and the singer hold a conversation. Accordingly, in the case of a program relating to music, the program can be divided into conversation segments and song segments.

With the example shown in FIG. 2, the program is configured such that the segment A is a conversation segment, segment B is a song segment, segment C is a conversation segment, segment D is a song segment, and segment E is a conversation segment, and the program can be thus segmented.

Also, segmenting wherein segment A is a main story of the program, and segment B is a commercial. Also in the case that the program is not related to music, and rather is a program of live sports, for example, the program may be segmented into a portion wherein the program is building up and a portion wherein the program is not building up.

Thus, one program can be segmented into multiple segments. The first segment is a predetermined scene of the segments thus segmented, and in this case is a song scene. According to the example described above, the first segment becomes a segment B and a segment D. Thus, the first segment is s predetermined scene of one program, and the scene thereof may appear multiple times.

The first segment will be further described with reference to FIG. 3. The example shown in FIG. 3 is an example wherein, of the multiple programs stored in the accumulating unit 22, there are three programs related to music, and each of the programs therein A through C are segmented into conversation segments and song segments (an example after which such processing is ended).

The program A is a music-related program wherein a song A is broadcast after a conversation A, a conversation B is broadcast after the song A, a song B is broadcast after the conversation B, and a conversation C is broadcast after the song B. Similarly, the program B is a music-related program wherein a song C is broadcast after a conversation D, a conversation E is broadcast after the song C, a song D is broadcast after the conversation E, a conversation F is broadcast after the song D, and a song E is broadcast after the conversation F. Similarly, the program C is a music-related program wherein a song F is broadcast after the conversation G, a song G is broadcast after the song F, a song H is broadcast after the song G, and a conversation H is broadcast after the song H.

In the case that such programs A through C are stored in the accumulating unit 22, a mode for continuously playing back only the songs within the program (hereafter will be described as song mode) is selected, and in the case that playback of a program in song mode is instructed, only the song segments are extracted from each program, and are continuously played back.

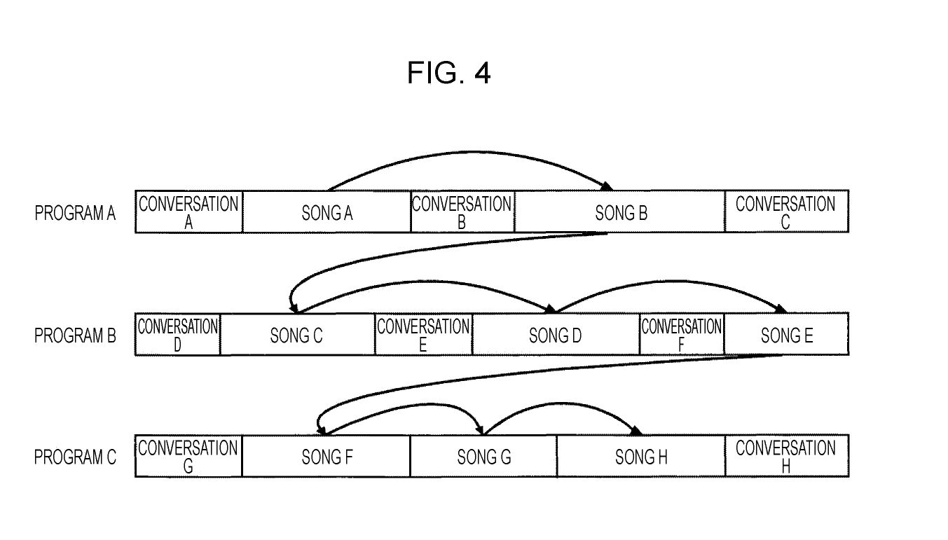

That is to say, in the case such as shown in FIG. 3, a song is continuously played back as shown in FIG. 4. Referencing FIG. 4, the song A of the program A is played back; upon the playback of the song A ending, the song B of the program A is played back; upon the playback of the song B ending, the song C of the program B is played back; upon the song C ending, the song D of the program B is played back; upon the playback of the song D ending, the song E of the program B is played back; upon the playback of the song E ending, the song F of the program C is played back; upon the playback of the song F ending, the song G of the program C is played back; and upon the playback of the song G ending, the song H of the program C is played back.

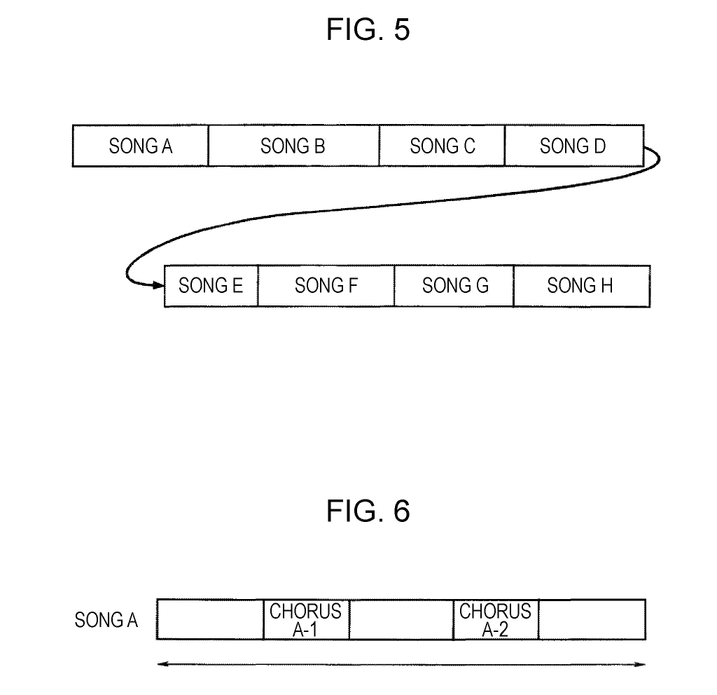

With such playback being performed, songs are provided in a flow such as that shown in FIG. 5. Referencing FIG. 5, song A, song B, song C, song D, song E, song F, song G, and song H in this sequence are continuously played back and provided to the user. Accordingly in this case, these are songs included in multiple programs, but only the song segments are provided to the user as if this was one program. In a program related to music, a segment having greater content meaning, i.e. a segment which the user desires to view/listen to is the segment wherein music, i.e. a song, is playing.

Accordingly, in this case, the user can continuously view/listen to only the segments of the 3 programs related to music that the user desires to view/listen to. In such as case, the user will have viewed/listened to 3 programs, albeit not necessarily completely. By enabling such viewing/listening, for example even in a case wherein a large number of programs are accumulated in the accumulating unit 22 and the user has difficulty in searching for a program to view/listen to, only segments that the user is likely to desire viewing/listening from the programs matching the desired genre of the user (in this case, the genre is music) are provided to the user, thereby enabling efficient viewing/listening.

With the above-described description, for example when referencing FIG. 4 again, the song B is played back after the song A, thus description is given that playback is in the sequence broadcast within one program. Also, description is given wherein, in the case that there are multiple programs, such as the song C of the program B being played back after the song B of the program A being played back, upon playback of all of the songs included in one program ending, playback of a song included in the next program is started. Thus, an arrangement may by made wherein there are predetermines rules to the order of songs to be played back, and playback is performed based on such rules, but an arrangement may be made having a rule wherein playback is randomly performed from the songs to be played back.

Next, the second segment will be further described. In this case, the second segment is chorus portion of a song. A segment called a chorus which builds up greatly within the song is included in a song. Referencing FIG. 6, chorus A-1 and chorus A-2 are included in the song A. A segment other than the chorus is included before the chorus A-1, between the choruses A-1 and A-2, and after the chorus A-2. Depending on the song, the position of the chorus (the amount of time passed from the starting point-in-time of the song), the length of the chorus, the number of times that the chorus is played and so forth differ, but a segment called a chorus will be included in the segment.

The second segment is a segment with such a chorus. The recording/playback device 11 has a mode to continuously play the chorus segments (hereafter called “chorus mode”). In the case that the chorus mode is selected by the user, the recording/playback device 11 further extracts and continuously plays back only the chorus segments from the songs within each program. As described with reference to FIG. 6, a chorus included in one song may be included only once, or may be included multiple times. In the case that multiple choruses are included in one song, description will be given as one chorus being played back in chorus mode. That is to say, description will be given below as when in chorus mode, one chorus segment is extracted from one song, and choruses of multiple songs are continuously played back.

Note that thus extracting and continuously playing back one chorus segment from one song is performed because normally, a chorus segment included in the same song has the same cadence and so forth, and prevents a situation wherein, even if multiple choruses are included in one song and the multiple choruses are continuously played back, only the choruses with the same cadence are repeated and becomes redundant.

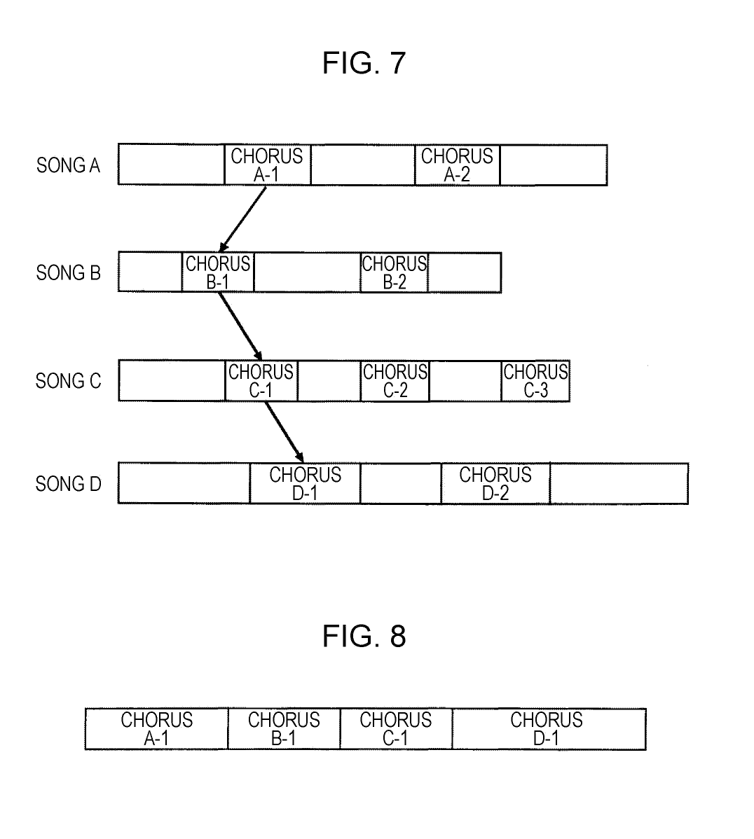

Playback in chorus mode will be further described with reference to FIG. 7. The example shown in FIG. 7 shows a case of playing back the choruses of four songs of songs A through D. In referencing FIG. 7, the chorus A-1 of the song A is played back; upon the playback of the chorus A-1 ending, the chorus B-1 of the song B is played back; upon the playback of the chorus B-1 ending, the chorus C-1 of the song C is played back, and upon the playback of the chorus C-1 ending, the chorus D-1 of the song D is played back.

With such playback being performed, the choruses are provided to the user in a flow such as shown in FIG. 8. Referencing FIG. 8, the choruses A-1, B-1, C-1, and D-1 are continuously played back in that sequence, and provided to the user. Accordingly in this case, only the chorus portions of the choruses included in the multiple songs are provided to the user. In a song, a segment having greater content meaning, i.e. a segment which leaves an impression on the user is the chorus segment.

Generally, if the user enjoys the segment leaving an impression, i.e. the chorus segment in this case, the probability of the user enjoying the song is increased, whereby continuously listening to only chorus portions of a song the user has not heard before in order to search for an enjoyable song is an effective method.

In this case, the user can continuously view/listen to only the segments leaving an impression from the four songs. In such a case, the user will have viewed/listened to 4 programs, albeit not necessarily completely. By enabling such viewing/listening, for example even in a case wherein a large number of programs are accumulated in the accumulating unit 22 and a desired song is likely to be included in these programs, when the desired song is to be searched, only the segments that the user is likely to desire viewing/listening from such programs are provided to the user, thereby enabling efficient viewing/listening and searching.

With the above description, referencing FIG. 7 again, when the song A has choruses A-1 and A-2 for example, the chorus A-1 which is played back first has been described as being played back, but an arrangement may be made wherein the chorus A-2 which is played back later is played back.

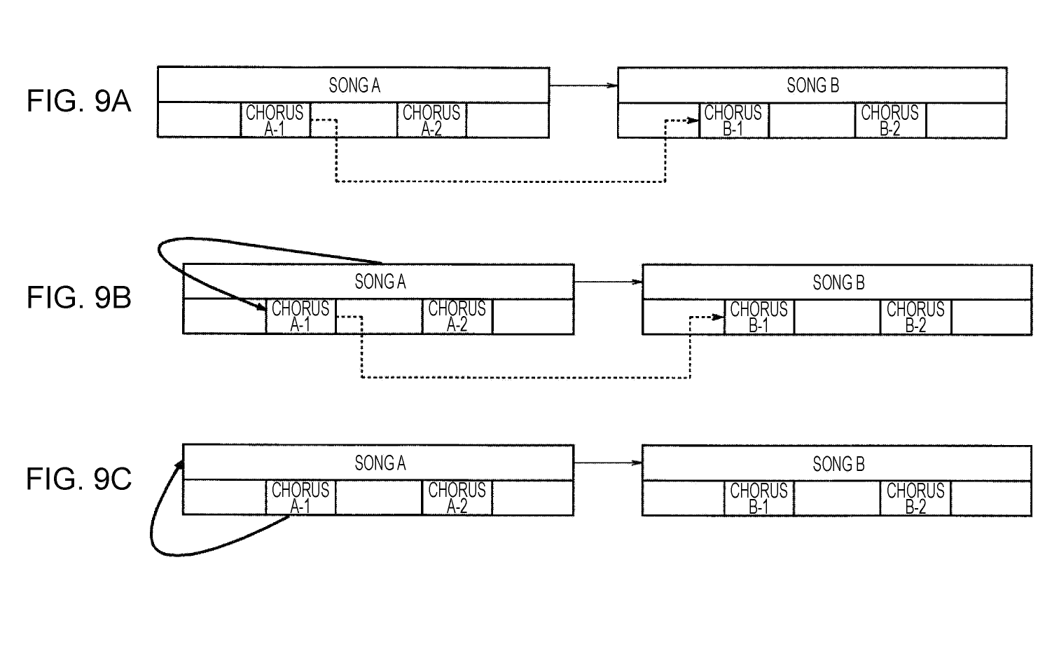

Thus, the recording/playback device 11 has a song mode to continuously play back the song mode and a chorus mode to continuously play back the chorus of the song. These modes are configured so as to be mutually switched. That is to say, the configuration thereof is such that switching from song mode to chorus mode, or switching from chorus mode to song mode, is enabled. Next, mode switching will be described further with reference to FIGS. 9A through 9C.

With FIGS. 9A through 9C, an example wherein two songs included in one program or two programs are played back. As shown in FIGS. 9A through 9C, the choruses A-1 and A-2 are included in the song A, and the choruses B-1 and B-2 are included in the song B. When in song mode, as shown with the solid line arrows in FIG. 9A, upon the song A being played back, the song B is played back. When in chorus mode, as shown with the dotted line arrows in FIG. 9A, upon the chorus A-1 of the song A being played, the chorus B-1 of the song B is played.

In referencing FIG. 9B, in the case that switching is instructed to chorus mode when in song mode and when the song A is being played back, the playback is transferred to the chorus A-1 of the song A. That is to say, the playback segment is changed to the chorus segment of the song being played back while in song more. If there is no more instruction, the chorus mode is continued, and after the chorus A-1 is played back, playback of the chorus B-1 is started.

Thus, when switching from song mode to chorus mode, by changing the playback segment to a chorus segment of the song being played back when in song mode, e.g. by switching to chorus mode when a song is played that the user does not enjoy, playing back an enjoyable song can be achieved in a short time.

Also, by changing the playback segment to a chorus segment of the song being played back when in song mode, e.g. for a case wherein the user does not enjoy the beginning of a song and therefore switches to chorus mode, but enjoys the chorus of such song and consequently enjoys the entire song, mode switching can be performed so as to allow such opportunities.

Note that description is given here such that the playback segment is changed to the chorus segment of the song being played back while in song mode, when switching from song mode to chorus mode, but an arrangement may be made wherein the playback segment of the change destination becomes a chorus segment of a song expected to be played back following the song being played back when in song mode. In this case, there is an advantage of arriving at playback of an enjoyable song in a short time.

Referencing FIG. 9C, in the case that switching to song mode is instructed while in chorus mode and while chorus A-1 is being played back, playback is transferred to the beginning of the song A. That is to say, the playback segment is changed to a song including the chorus being played back during chorus mode. If there is no more instruction, the song mode is continued, and after the song A is played back, playback of the song B is started.

Thus, when switching from chorus mode to song more, by the playback segment changing to a song including the chorus played back during chorus mode, e.g. by the user switching to song mode while a chorus that the user enjoys is being played back, the enjoyable song thereof can be listened to again from the beginning.

Also, in the case that the program is a television broadcast program, the song information is often displayed at the beginning of the song. For example, information such as title of song, name of singer, composer, lyricist and so forth is often displayed as a caption. Considering such a situation, if there is an enjoyable segment while in chorus mode and the user switches to song mode, whereby the song is played back from the beginning, and the information of the enjoyable song can be obtained, a situation that is favorable to the user can be provided.

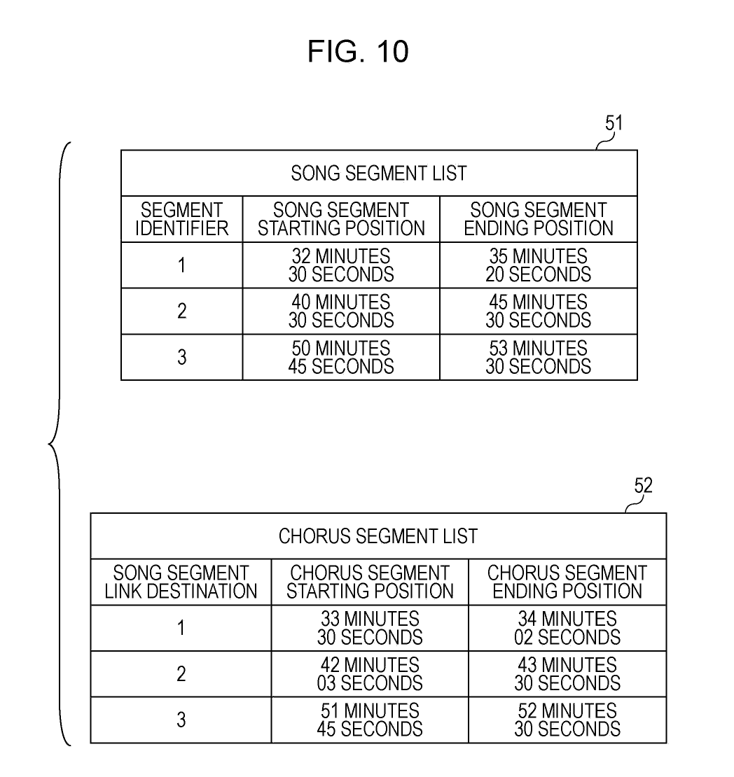

In order to realize such switching from song mode to chorus mode or from chorus mode to song mode, the recording/playback device 11 creates and holds two lists such as those shown in FIG. 10.

Referencing FIG. 10, of the two lists held by the recording/playback device 11, one is a song segment list and the other is a chorus segment list.

A song segment list 51 has items provided therein called a segment identifier, song segment starting position, and song segment ending position. The segment identifies is assigned to a song segment within the program, and is an identifier to uniquely identify a predetermined song segment.

The song segment starting position is the time from the program starting point-in-time until the song segment starts. Description will be continued with the song segment starting position as the time from the program starting point-in-time being written, but an arrangement may be made wherein other information is written such as a starting address of a song segment in the accumulating unit 22.

The song segment ending position is the time until the song segment from the starting point-in-time of the program is ended. Similar to the song segment starting position, the information written in the song segment ending position may be information other than time such as an address.

For example, we can see that a song segment with a segment identifier of “1” is from the point-in-time having passed the beginning of the predetermined program by “32 minutes 30 seconds” until “35 minutes 20 seconds”, by referencing the song segment list 51.

The chorus segment list 52 has items provided called a song segment link destination, chorus segment starting position, and chorus segment ending position. The song segment link destination is a segment identifier of a song including a chorus segment.

The chorus segment starting position is the time from the program starting point-in-time until the chorus segment starts. Description will be continued with the chorus segment starting position as the time from the program starting point-in-time being written, but an arrangement may be made wherein other information is written such as a starting address of a chorus segment in the accumulating unit 22, or the time passed from the song starting point-in-time.

The chorus segment ending position is the time from the program starting point-in-time until the chorus segment is ended. Similar to the chorus segment starting position, the information written in the chorus segment ending position may be information other than time such as an address.

For example, a chorus segment with a song segment link destination of “1” is a chorus included in the song segment with the segment identifies “1”, and we can see that the segment is from the point-in-time having passed the beginning of the predetermined program by “33 minutes 30 seconds” until “34 minutes 02 seconds”, by referencing the chorus segment list 52.

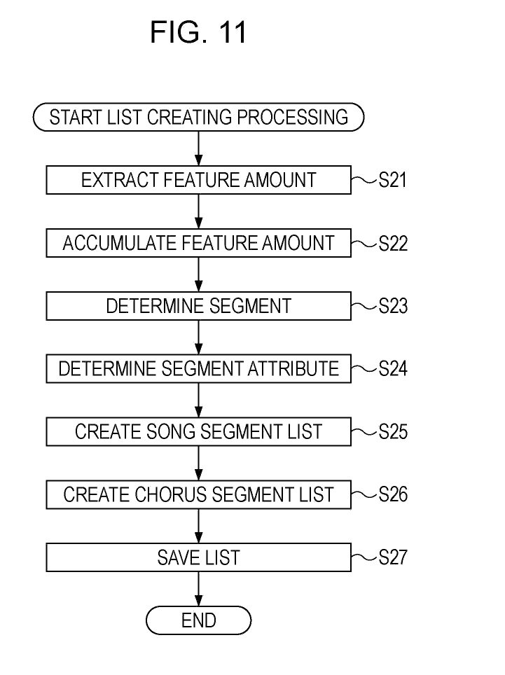

The creation of such a song segment list 51 and chorus segment list 52 will be described with reference to the flowchart in FIG. 11. The processing in this flowchart is started when a television broadcast program is received from the broadcast receiving unit 21 and accumulation of the program is started in the accumulating unit 22.

In step S11, the feature amount extracting unit 23 obtains a program received by the broadcast receiving unit 21, and extracts the feature amount from the program. The obtained program is made up of pictures and audio. In the case of extracting a feature amount from a picture, the feature amount extracting unit 23 extracts the feature amount with edge detecting or motion vector detecting, for example, or in the case of extracting a feature amount from audio, extracts a feature amount with analysis of volume or melody, for example.

In step S22, the extracted feature amount is temporarily accumulated in the feature amount accumulating unit 24. In step S23, the segment determining unit 25 references the feature amount accumulated in the feature amount accumulating unit 24, and determines predetermined scene breaks such as scene changes, or the starting or ending of a commercial. In step S24, the segment attribute determining unit 26 determines what sort of attribute the segment belongs to for the segment determined by the segment determining unit 25 (segment from break to the next break).

An arrangement may be made wherein the feature amount extracted by the feature amount extracting unit 23 is determined depending on what kind of segment to determine with the segment determining unit 25, or depending on what kind of attribute to associate with the segment determined with the segment attribute determining unit 26.

For example, in this case, the song segment and chorus segment are to be extracted, so processing is performed such that the feature amount is extracted by analyzing the audio, switching from the conversation segment to the song segment or switching from the song segment to the conversation segment is determined, and the conversation segment or song segment from the switching point to the next switching point is called an attribute.

With the processing up to this point, the song segment is extracted. Also, while the song segment is extracted, extracting of the chorus segment is also performed. The chorus segment can be extracted by analyzing the song in an extracted song segment. The song segment has an attribute associated to the song segment with the segment attribute determining unit 26, and the chorus segment has an attribute associated to the chorus segment with the segment attribute determining unit 26.

Upon the song segment and chorus segment being extracted, a song segment list is created in step S25. The playback segment group generating unit 27 generates the song segment list 51 shown in FIG. 10 from the segment with an attribute called a song segment associated. Also, the playback segment group generating unit 27 generates the chorus segment list 52 shown in FIG. 10 from the segment with an attribute called a chorus segment attached.

The song segment list 51 and chorus segment list 52 thus generated are accumulated (held) in the accumulating unit 22 in step S27.

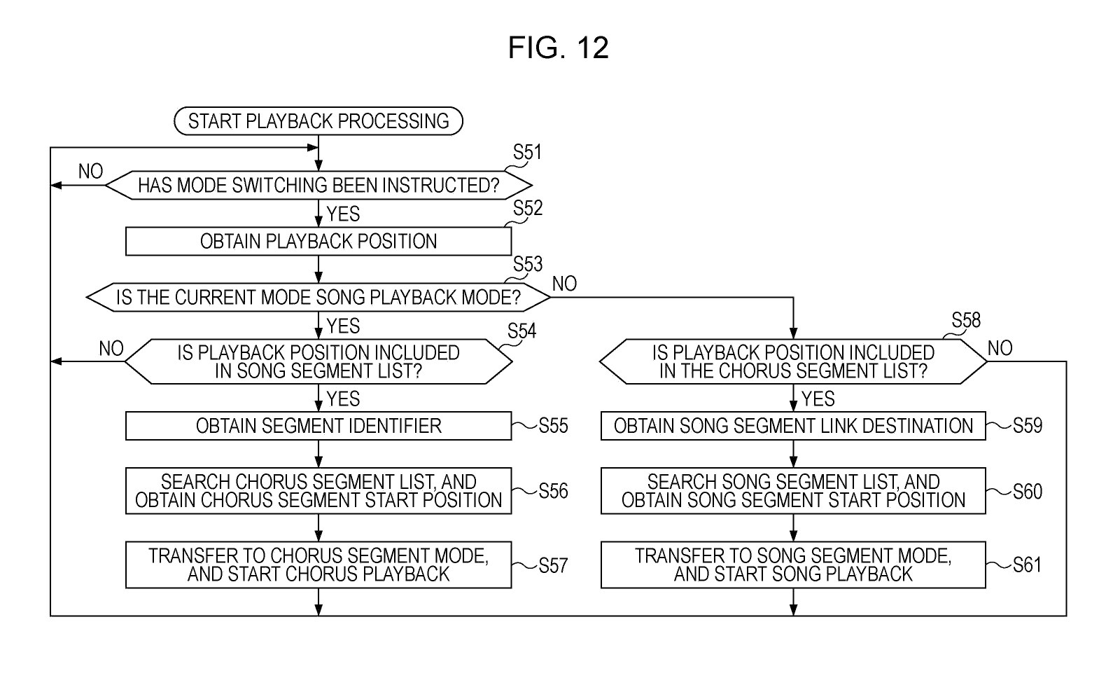

Next, the processing at the time of playback in song mode or in chorus mode when such song segment list 51 and chorus segment list 52 are accumulated in the accumulating unit 22, with reference to the flowchart in FIG. 12.

In step S51, whether the mode switching is instructed or not is determined. This determination is made by the user operation receiving unit 29 determining whether or not a button is operated that is to be operated when switching the mode, for example. In step S51, in the case that determination is made that mode switching is instructed, the flow is advanced to step S52, and in the case that determination is made that mode switching is not instructed, a standby state is maintained.

In step S52, the playback position at that point-in-time is obtained. In step S53, determination is made as to whether or not the current state mode is song mode. The segment group playback unit 28 determines whether or not the current state mode is in song mode, by determining whether or not a segment being played back at the point-in-time when mode switching is instructed is a song segment.

In the case that determination is made in step S53 of song mode, the processing is advanced to step S54. In step S54, determination is made as to whether or not the playback position is included in the song segment list. In the case determination is made in step S54 that the playback position is not included in the song segment list, the flow is returned to step S51, and the processing thereafter is repeated. On the other hand, in the case determination is made that the playback position is included in the song segment list, the flow is advanced to step S55.

In step S55, a segment identifier is obtained. The segment group playback unit 28 searches a segment including the playback position from the song segment list 51 referenced at that point-in-time, and reads out a segment identifier of the segment including such playback position. For example, in the case that the playback position is “33 minutes 33 seconds”, then referencing the song segment list 51 (FIG. 10), the “33 minutes 33 seconds” is between the song segment starting position of “32 minutes 30 seconds” and the song segment ending position of “35 minutes 20 seconds”, whereby the segment identifier is read out as “1”.

In step S56, the chorus segment list 52 is searched and the chorus segment starting position is obtained. The segment group playback unit 28 searches the chorus segment list 52 based on the obtained segment identifier, and obtains the chorus segment starting position. For example, in the case that the obtained segment identifier is “1”, the song segment link destination having the same value as the segment identifier, i.e. in this case the chorus segment having a song segment link destination of “1” is set as the chorus segment to be played back, and the chorus segment starting position “33 minutes 30 seconds” having a song segment link destination of “1” in the chorus segment list 52 is read out as the playback starting position of the chorus segment.

In step S57, the mode is transferred to chorus mode, and playback of the chorus segment is started from the playback starting position of the read out chorus segment. Upon the processing in step S57 ending, the flow is returned to step S51, and the processing thereafter is repeated.

Such processing to transfer from song mode to chorus mode is performed as described with reference to FIG. 9B, whereby as described above, the processing is performed by referencing the song segment list 51 and the chorus segment list 52. Also, the processing in chorus mode is performed as described with reference to FIG. 7, and the processing thereof is performed by the chorus segment list 52 being referenced.

On the other hand, in step S53, in the case that the current mode is determined not to be a song mode, i.e. in the case determination is made of a chorus mode, the flow is advanced to step S58.

In step S58, determination is made as to whether or not the playback position is included in the chorus segment list 52. In the event determination is made in step S58 that the playback position is not included in the chorus segment list 52, the flow in step S51 is returned, and the processing thereafter is repeated. On the other hand, in the case determination is made in step S58 that the playback position is included in the chorus segment list, the flow is advanced to step S59.

In step S59, the song segment link destination is obtained. The segment group playback unit 28 searches a segment including the playback position from the chorus segment list 52 referencing at that point-in-time, and reads out the song segment link destination of the segment included in the playback position thereof. For example, in the case that the playback position is “33 minutes 50 seconds”, referencing the chorus segment list 52 (FIG. 10), the “33 minutes 50 seconds” is between the chorus segment starting position of “33 minutes 30 seconds” and the chorus segment ending position of “34 minutes 02 seconds”, so the song segment link destination is read out as “1”.

In step S60, the song segment list 51 is searched, and the song segment starting position is obtained. The segment group playback unit 28 searches the song segment list 51 based on the obtained song segment link destination, and obtains the song segment starting position. For example, in the case that the obtained song segment link destination is “1”, the segment identifier of the same value as the song segment link destination, i.e. in this case the song segment with a segment identifier of “1”, is set as the song segment to be played, and song segment starting position “32 minutes 30 seconds” having the segment identifier of “1” of the song segment list 51 is read out as the song segment playback starting position.

In step S61, the mode is transferred to song mode, and playback of the song segment is started from the read out song segment playback starting position. Upon the processing is step S61 ending, the flow is returned to step S51, and the processing thereafter is repeated.

Such processing to transfer from bride mode to song mode is performed as described with reference to FIG. 9C, whereby, as described above, the processing is performed by referencing the song segment list 51 and chorus segment list 52. Also the processing is song mode is performed as described with reference to FIG. 4, and the processing thereof is performed by referencing the song segment list 51.

Thus, the song mode and chorus mode can be switched, whereby in a case that a user does not enjoy a song being played back during song mode, a configuration can be provided to enable viewing/listening to the chorus segment and searching for a desired song. Also, the song mode and chorus mode can be switched, for example, whereby in a case that a user enjoys a chorus being played back during chorus mode, a configuration can be provided to enable viewing/listening to the song segment, searching quickly for a desired song, and obtaining the information of the song.

Also, by enabling continuous playback of the primary portions only by the song mode and chorus mode, for example, a program accumulated in a hard disk recorder or the like can be efficiently viewed/listened to.

Note that the above-described series of processing can be executed with hardware, or can be executed with software. In the case of executing the above-described series of processing with software, a program making up such software is installed into a computer built into dedicated hardware, or onto a general-use computer, for example, which can execute various types of functions by installing various types of programs.

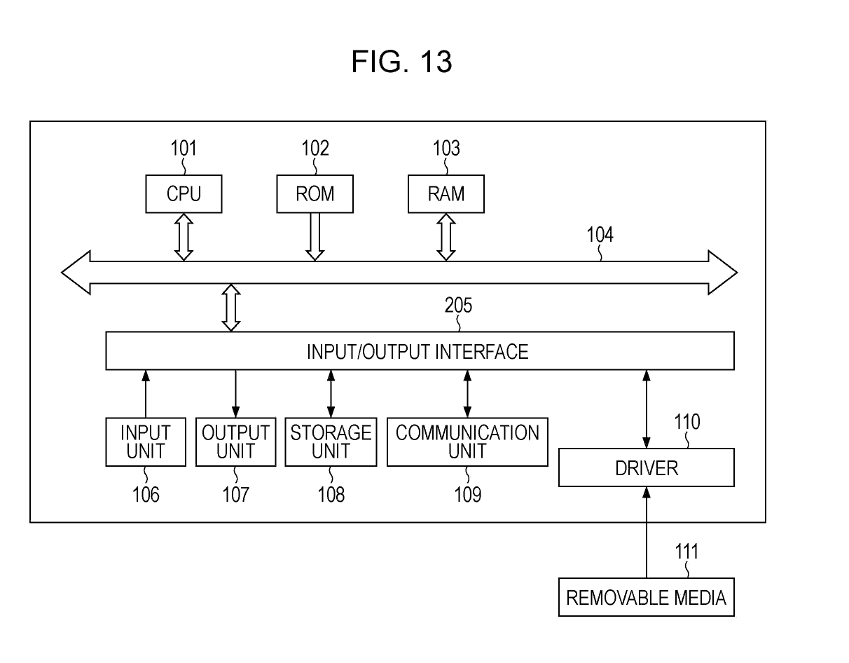

FIG. 13 is a block diagram showing a configuration example of hardware of a personal computer that executes the above-described series of processing with a program.

With a computer, a CPU (Central Processing Unit) 101, ROM (Read Only Memory) 102, and RAM (Random Access Memory) 103 are mutually connected by a bus 104. The bus 104 is also connected to an input/output interface 105. The input/output interface 105 is connected to an input unit 106 made up of a keyboard, mouse, microphone, and the like, an output unit 107 made up of a display, speaker and the like, a storage unit 108 made up of a hard disk, non-volatile memory, and the like, a communication unit 109 made up of a network interface and the like, and a driver 110 to drive a removable media 111 such as a magnetic disk, optical disk, optical-magnetic disk, or semiconductor memory and the like.

With a computer thus configured, for example the CPU 101 loads the program stored in the storage unit 108 onto the RAM 103, via the input/output interface 105 and bus 104, and executes, whereby the above-described series of processing is performed.

A program that the computer (CPU 101) executes is recorded onto a removable medium 111 such as a packaged medium made up of a magnetic disk (including flexible disk), optical disk (CD-ROM (Compact Disc-Read Only Memory), and DVD (Digital Versatile Disk) and the like), optical-magnetic disk, or semiconductor memory and the like, and is provided via cable or wireless transmission medium, such as a local area network, the Internet, or a digital satellite broadcast.

By mounting the removable media 111 to the driver 110, the program can be installed on the storage unit 108 via the input/output interface 105. Also, the program can be received with the communication unit 109 via a cable or wireless transmission medium, and installed in the storage unit 108. Alternatively, the program can be installed beforehand in the ROM 102 or storage unit 108.

Note that the program which the computer executes may be a program wherein processing is performed in a time-series manner along the order described in the present specification, or may be a program wherein processing is performed in parallel, or in a suitable timing when called up.

Also, with the present specification, the term “system” means the entirety of equipment made up of multiple devices.

The embodiments of the present invention are not restricted to the above-described embodiments, and various types of modifications may be made within the scope of the present invention. It should be understood by those skilled in the art that various modifications, combinations, sub-combinations and alterations may occur depending on design requirements and other factors insofar as they are within the scope of the appended claims or the equivalents thereof.

1. A recording/playback device comprising:
extracting means configured to extract a feature amount for detecting a content break;
break determining means configured to determine said content break using said feature amount extracted with said extracting means;
attribute determining means configured to determine the attributes of a segment, such segment being made from a predetermined break to a next break based on determination by said break determining means; and
playback means configured to continuously play back the segment determined by said attribute determining means to have the same attributes;
wherein said break determining means determines each of a first segment and a second segment included in the first segment;
and wherein said playback means have
a first mode to continuously play back said first segment and
a second mode to continuously play back said second segment,
said playback means switching between said first mode and said second mode when instructed externally.

2. The recording/playback device according to claim 1, wherein, in the case that switching from said first mode to said second mode is instructed, the playback is switched from said first segment being played back at that point-in-time to playback of said second segment, and
in the case that switching from said second mode to said first mode is instructed, the playback is switched from said second segment being played back at that point-in-time to playback of the beginning of said first segment.

3. The recording/playback device according to claim 1, wherein said first segment is a song segment, and said second segment is a segment of a chorus of said song.

4. The recording/playback device according to claim 1, wherein said attribute determining means creates
a first table associating an identifier to identify said first segment with the starting point-in-time and ending point-in-time of said first segment, and
a second table associating an identifier to associate said second segment and said first segment with the starting point-in-time and ending point-in-time of said second segment;
said playback means performing playback with reference to said first table or said second table.

5. A recording/playback method comprising:
extracting a feature amount for detecting a content break;
determining said content break using said feature amount;
determining the attributes of a segment, such segment being made from a predetermined break to a next break based on determination by said break determining means; and
controlling continuous playback of the segment determined to have the same attributes;
wherein, in said break determining step, a first segment and a second segment included in the first segment are each determined;
and wherein said playback step has
a first mode to continuously play back said first segment and
a second mode to continuously play back said second segment,
with said first mode and said second mode being switched between when instructed externally.

6. A program to cause a computer to execute processing including:
extracting a feature amount for detecting a content break;
determining said content break using said feature amount;
determining the attributes of a segment, such segment being made from a predetermined break to a next break based on determination by said break determining means; and
controlling continuous playback of the segment determined to have the same attributes; wherein
said break determining step determines each of a first segment and a second segment included in the first segment; and
wherein, in said break determining step, a first segment and a second segment included in the first segment are each determined;
and wherein said playback step has
a first mode to continuously play back said first segment and
a second mode to continuously play back said second segment,
with said first mode and said second mode being switched between when instructed externally.

7. A recording medium having recorded a program to cause a computer to execute processing including:
extracting a feature amount for detecting a content break;
determining said content break using said feature amount;
determining the attributes of a segment, such segment being made from a predetermined break to a next break based on determination by said break determining means; and
controlling continuous playback of the segment determined to have the same attributes; wherein
said break determining step determines each of a first segment and a second segment included in the first segment; and
wherein, in said break determining step, a first segment and a second segment included in the first segment are each determined;
and wherein said playback step has
a first mode to continuously play back said first segment and
a second mode to continuously play back said second segment,
with said first mode and said second mode being switched between when instructed externally.

8. A recording/playback device comprising:
an extracting unit configured to extract a feature amount for detecting a content break;
a break determining unit configured to determine said content break using said feature amount extracted with said extracting unit;
an attribute determining unit configured to determine the attributes of a segment, such segment being made from a predetermined break to a next break based on determination by said break determining unit; and
a playback unit configured to continuously play back the segment determined by said attribute determining unit to have the same attributes;
wherein said break determining unit determines each of a first segment and a second segment included in the first segment;
and wherein said playback unit has
a first mode to continuously play back said first segment and
a second mode to continuously play back said second segment,
said playback unit switching between said first mode and said second mode when instructed externally.
